(19) United States
(12) Patent Application Publication
(10) Pub. No.: US 2022/0332099 A1
(43) Pub. Date: Oct. 20, 2022

(54) FIRE RETARDANT ABSORPTION MAT

(71) Applicant: Aereos Interior Solutions, Euless, TX (US)

(72) Inventors: Paul KENNY, Thousand Oaks, CA (US); Evelyn Hana KIM, Decatur, GA (US)

(73) Assignee: Aereos Interior Solutions, Euless, TX (US)

(21) Appl. No.: 17/724,914

(22) Filed: Apr. 20, 2022

Related U.S. Application Data
(60) Provisional application No. 63/177,112, filed on Apr. 20, 2021.

(51) Int. Cl. B32B 27/12; B32B 27/30; B32B 7/12; B32B 5/02; C09J 133/08; B64C 1/18

(52) U.S. Cl. CPC B32B 27/12; B32B 27/304; B32B 7/12; B32B 5/024; B32B 5/022; C09J 133/08; B64C 1/18; B32B 2307/3065; B32B 2307/7145; B32B 2471/04; B32B 2605/18; B32B 2250/02; B32B 2605/003

(57) ABSTRACT

A floor mat for use in a commercial aircraft application includes a base carpet-like section made of a fire rated material. A backing film layer is mounted to a bottom of the base carpet-like section. This mounting may be made, for example, using an intervening adhesive layer or through a direct attachment using an inherent adhesive property of the backing film layer. The backing film layer (and any adhesive layer that is used) is made of a fire retardant material. The base carpet-like section is porous and absorbent, and the backing film layer provides a moisture barrier as well as an anti-slip feature.

### CROSS-REFERENCE TO RELATED APPLICATIONS

This application claims priority from U.S. Provisional Application for Patent No. 63/177,112, filed Apr. 20, 2021, the disclosure of which is incorporated herein by reference.

### TECHNICAL FIELD

Modes of implementation and embodiments relate to a floor mat useful in areas where spillage of or exposure to liquids is likely. More specifically, embodiments disclosed herein concern a floor mat having fire retardant and anti-slip properties for use in certain hard floor surface areas of a commercial aircraft (such as in a galley, kitchen, entry, lavatory, bathroom).

### BACKGROUND

The floor covering used in a commercial aircraft is typically dependent on the use of the area being covered. For example, it is common for the passenger seating and aisle areas to be covered by some form of an industrial carpet. Other areas such as in a galley, kitchen, entry, lavatory, bathroom may utilize a vinyl floor tile or sheet.

It is imperative that the materials (including finishes or decorative surfaces applied to the materials) used in the aircraft compartment occupied by the crew or passengers meet certain test criteria. See, 14 CFR 25.853(a) and the twelve second vertical burn test. A floor mat for use on the vinyl floor tile or sheet in the galley, kitchen, entry, lavatory, bathroom area of the commercial aircraft therefore must satisfy the required test criteria (for example, in terms of being fire rated). There is a need in the art for such a floor mat.

### SUMMARY

In an embodiment, an apparatus comprises: a base carpet-like section made of a fire rated material and a backing film layer mounted to a bottom of the base carpet-like section. The backing film layer is made of fire retardant material.

In an embodiment, an intervening adhesive layer is used to secure the base carpet-like section to the backing film layer. This adhesive layer is also made of a fire retardant material.

In an alternative embodiment, the backing film layer may be made of a material with inherent adhesive properties to support being secured to the bottom of the base carpet-like section.

In an alternative embodiment, the base carpet-like section may be fused, for example, through a heat and/or pressure treatment, directly to backing film layer.

### BRIEF DESCRIPTION OF THE DRAWINGS

Other advantages and features of the invention will become apparent on examining the detailed description of completely non-limiting modes of implementation and embodiments and the appended drawings, in which:

FIG. 1 is a cut-away perspective view of a floor mat;

FIG. 2 is a cross-section view of the floor mat;

FIG. 3 is an exploded perspective view of the floor mat;

FIG. 4 is a top view of the floor mat; and

FIG. 5 is an exploded perspective view of an alternative embodiment for the floor mat.

### DETAILED DESCRIPTION

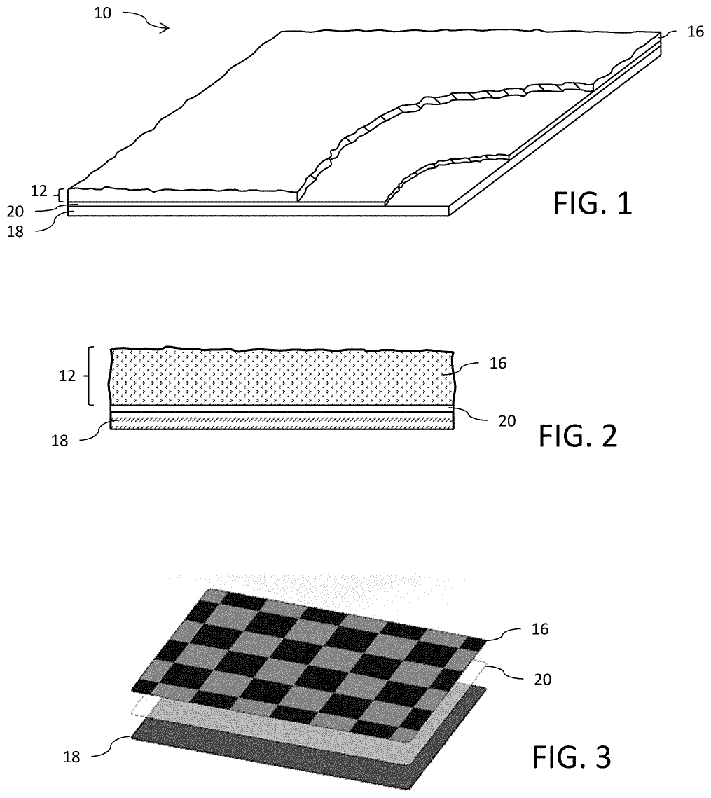

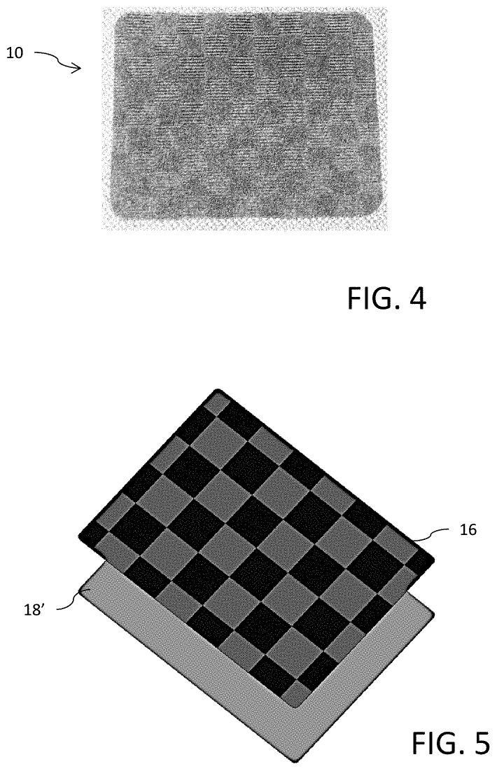

Reference is now made to FIG. 1 which shows a cut-away perspective view of a floor mat 10, and also to FIG. 2 which shows a cross-section view of the floor mat, and also to FIG. 3 which shows an exploded perspective view of the floor mat 10, and also to FIG. 4 which shows a top view of the floor mat 10. The floor mat 10 is a multi-layer construction. A base carpet-like section 12 is formed by a woven or non-woven fiber layer 16. The base carpet-like section 12 is porous, but the fiber layer 16 is, generally speaking, liquid absorbing. The base carpet-like section 12 is preferably made of a polypropylene material. In a preferred implementation, the polypropylene material for the base carpet-like section 12 is a fire rated material such as fire rated or resistant polypropylene plastic (PPP). In this context, this means the material has met the requirements of 14 CFR 25.853(a) and the twelve second vertical burn test. In a preferred implementation, the base carpet-like section 12 is an anti-microbial product.

In this context, this means that the material is capable of destroying or inhibiting the growth of microorganisms. The base carpet-like section 12 may comprise a commercially available product such as a restroom mat. In a top down view as shown in FIG. 4, the base carpet-like section 12 may have any suitable geometric shape, with square and rectangular being common shape choices.

The bottom surface of the fiber layer 16 for base carpet-like section 12 is mounted to a backing film layer 18 through use of an adhesive layer 20. The backing film layer 18 is made of fire retardant polyvinyl-chloride (PVC) vinyl material. In this context, fire retardant means that the material has met the requirements of 14 CFR 25.853(a) and the twelve second vertical burn test. The backing film layer 18 may comprise a commercially available product such as fire rated or resistant vinyl sheet. For example, an industrial coated vinyl (PVC material) with fire retardant from Big Duck Canvas could be used for film layer 18. The adhesive layer 20 may also be made of a fire rated acrylic material In this context, fire rated means that the material has met the requirements of 14 CFR 25.853(a) and the twelve second vertical burn test. The adhesive layer 20 may comprise a commercially available product such as a fire retardant FLEXcon® V-59FR tackified acrylic pressure sensitive adhesive. The backing film layer 18 provided is mounted to the bottom surface of the fiber layer 16 of the base carpet-like section 12 for at least the purposes of providing a moisture barrier (with respect to the absorbent, yet porous, base carpet-like section 12) and providing an anti-slip function when the mat 10 is installed on a hard floor surface (such as a vinyl tile floor).

In an alternative embodiment, as shown in FIG. 5, the floor mat 10 is still a multi-layer construction, but in this case is formed by two layers: the base carpet-like section 12 (having the materials and properties described above) and a backing film layer 18′. The backing film layer 18′ is made of a fire retardant material (i.e., the material has met the requirements of 14 CFR 25.853(a) and the twelve second vertical burn test). The construction of the mat in FIG. 5 differs from that of FIGS. 1-4 in that the base carpet-like section 12 is directly mounted to the backing film layer 18′ without use of an intervening adhesive layer (see, layer 20). In this case, the material of the backing film layer 18′ has inherent adhesive properties that permit securing the base carpet-like section 12. For example, the material of the backing film layer 18′ may exhibit a tackiness (which is well suited for its anti-slip characteristic) that satisfactorily secures the backing film layer 18′ to the underside of the base carpet-like section 12. The application of one or both of heat and/or pressure when mounting the base carpet-like section 12 directly to the backing film layer 18′ may assist in providing for a fusing to occur between the underside of the base carpet-like section 12 and the upperside of the backing film layer 18′. The backing film layer 18′ may, for example, be made of a rubber material that has anti-skid properties but is malleable enough under the application of heat and/or pressure to bond to the polypropylene fibers of the base carpet-like section 12.

While the invention has been illustrated and described in detail in the drawings and foregoing description, such illustration and description are considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

1. An apparatus, comprising:
a base carpet-like section made of a fire rated material; and
a backing film layer mounted to a bottom of the base carpet-like section;
wherein said backing film layer is made of a fire retardant material.

2. The apparatus of claim 1, wherein the backing film layer is made of fire retardant PVC vinyl.

3. The apparatus of claim 1, further comprising an adhesive layer between the base carpet-like section and the backing film layer, wherein said adhesive layer is made of a fire retardant material.

4. The apparatus of claim 3, wherein the adhesive layer is a pressure sensitive adhesive layer.

5. The apparatus of claim 4, where the pressure sensitive adhesive layer comprises a tackified acrylic pressure sensitive adhesive.

6. The apparatus of claim 3, wherein the adhesive layer is a fire rated acrylic material layer.

7. The apparatus of claim 1, wherein the backing film layer has an inherent adhesive property for securely attaching to the bottom of the base carpet-like section.

8. The apparatus of claim 7, wherein the inherent adhesive property is a tackiness.

9. The apparatus of claim 7, wherein the backing film layer is fused to the bottom of the base carpet-like section.

10. The apparatus of claim 9, wherein the fusing of the backing film layer is fused to the bottom of the base carpet-like section is heat fusing.

11. The apparatus of claim 9, wherein the fusing of the backing film layer is fused to the bottom of the base carpet-like section is pressure fusing.

12. The apparatus of claim 1, wherein the base carpet-like section is anti-microbial.

13. The apparatus of claim 1, forming a floor mat for use in a commercial aircraft which satisfies the requirements of 14 CFR 25.853(a) and meets a twelve second vertical burn test.

14. The apparatus of claim 1, forming a floor mat for use in a commercial aircraft.
